(19) United States
(12) Patent Application Publication
(10) Pub. No.: US 2026/0014621 A1
(43) Pub. Date: Jan. 15, 2026

(54) MAGNETIC POWDER HOT-PRESSING AND HOT-DEFORMATION APPARATUSES AND HOT-PRESSING AND HOT-DEFORMATION METHODS

(71) Applicant: BAOTOU RESEARCH INSTITUTE OF RARE EARTHS, Baotou (CN)

(72) Inventors: Jianlong Fu, Baotou (CN); Yanwei Song, Baotou (CN); Yan Gao, Baotou (CN); Deying Zhu, Baotou (CN); Dongbo Wang, Baotou (CN); Guozheng Liu, Baotou (CN); Kai Qu, Baotou (CN); Haiyang Yu, Baotou (CN); Yu Wang, Baotou (CN); Wenliang Xie, Baotou (CN)

(73) Assignee: BAOTOU RESEARCH INSTITUTE OF RARE EARTHS, Baotou (CN)

(21) Appl. No.: 19/334,554

(22) Filed: Sep. 19, 2025

(30) Foreign Application Priority Data
Sep. 26, 2024 (CN) 202411347568.0

(51) Int. Cl. B22F 3/14; B22F 3/00; H01F 41/02

(52) U.S. Cl. CPC B22F 3/14; B22F 3/003; H01F 41/0266; B22F 2301/355

(57) ABSTRACT

The present disclosure provides a magnetic powder hot-pressing and hot-deformation apparatus and a hot-pressing and hot-deformation method. The magnetic powder hot-pressing and hot-deformation apparatus comprises a female die, an upper punch assembly, and a lower punch assembly. The upper punch assembly comprises an upper inner punch and an upper outer sleeve. At least a portion of the upper inner punch is inserted into the upper outer sleeve cavity, and the upper inner punch is configured to be movable vertically relative to the upper outer sleeve. The lower punch assembly comprises a lower inner punch and a lower outer sleeve. At least a portion of the lower inner punch is inserted into the lower outer sleeve cavity, and the lower inner punch is configured to be movable vertically relative to the lower outer sleeve. The diameter of the lower outer sleeve cavity is smaller than the diameter of the upper outer sleeve cavity. The magnetic powder hot-pressing and hot-deformation apparatus can improve the magnetic properties of NdFeB magnets.

### TECHNICAL FIELD OF THE DISCLOSURE

The present disclosure relates to a magnetic powder hot-pressing and hot-deformation apparatus and a hot-pressing and hot-deformation method.

### BACKGROUND OF THE DISCLOSURE

NdFeB magnets are the third-generation rare-earth permanent magnetic materials, known for their high magnetic properties and excellent cost-effectiveness. They are widely used in machinery, information technology, energy, transportation, and other fields. The hot-pressing and hot-deformation process is a near-net-shape manufacturing technology.

CN108022743A discloses a magnet apparatus comprising a machine base fixing seat, an inner die, a multi-action outer die, and a punch. The inner die is fixedly arranged on the machine base fixing seat. The multi-action outer die is disposed around the inner die. When the multi-action outer die moves relative to the inner die to a first position and a second position, a first accommodating space and a second accommodating space are respectively defined between the multi-action outer die and the inner die, with the first accommodating space and the second accommodating space having a first inner diameter and a second inner diameter, respectively. When the multi-action outer die moves to the first position, the punch is used to compact a magnetic ingot located inside the first accommodating space into an isotropic magnet semi-finished product. When the multi-action outer die moves to the second position, the punch is used to extrude the isotropic magnet semi-finished product located inside the second accommodating space into a hollow anisotropic magnet.

CN117116644A discloses a forming die for hot-pressed and hot-deformed magnets, comprising a fixed die, a first movable die, a second movable die, and a third movable die. The fixed die is provided with first and second die cavities that share the same central axis and communicate, wherein the cross-section of the first die cavity is larger than that of the second die cavity. The first movable die matches the second die cavity and is capable of moving along the central axis in both the first and second die cavities. The third movable die is slidably sleeved around the second movable die, and the combination of the second and third movable dies matches the first die cavity. The second movable die is capable of moving along the central axis in the first and second die cavities, while the third movable die is capable of moving along the central axis in the first die cavity. The second movable die matches the second die cavity.

The dies described above subject the compact from hot-pressing directly to high-temperature hot-deformation. The prolonged exposure of the compact to high temperatures can easily cause cracks in the magnet and degrade its magnetic properties.

### SUMMARY OF THE DISCLOSURE

In view of the above, one objective of the present disclosure is to provide a magnetic powder hot-pressing and hot-deformation apparatus capable of improving the magnetic properties of NdFeB magnets. Another objective of the present disclosure is to provide a hot-pressing and hot-deformation method capable of improving the magnetic properties of NdFeB magnets.

The objectives of the present disclosure are accomplished by technical solutions described below.

One aspect of the present disclosure provides a magnetic powder hot-pressing and hot-deformation apparatus, comprising a female die, an upper punch assembly, and a lower punch assembly,
wherein the female die comprises a die cavity comprising an upper cavity opening and a lower cavity opening;
the upper punch assembly comprises an upper inner punch and an upper outer sleeve, wherein the upper outer sleeve comprises an upper outer sleeve cavity, at least a portion of the upper inner punch is inserted into the upper outer sleeve cavity, the upper inner punch is configured to be movable vertically relative to the upper outer sleeve, and the outer diameter of the upper inner punch matches the diameter of the upper outer sleeve cavity; and
the lower punch assembly comprises a lower inner punch and a lower outer sleeve, wherein the lower outer sleeve comprises a lower outer sleeve cavity, at least a portion of the lower inner punch is inserted into the lower outer sleeve cavity, the lower inner punch is configured to be movable vertically relative to the lower outer sleeve, the diameter of the lower outer sleeve cavity is smaller than the diameter of the upper outer sleeve cavity, and the outer diameter of the lower inner punch matches the diameter of the lower outer sleeve cavity.

In the magnetic powder hot-pressing and hot-deformation apparatus according to the present disclosure, preferably, the outer diameter of at least a portion of the upper outer sleeve matches the diameter of the die cavity, and the outer diameter of at least a portion of the lower outer sleeve matches the diameter of the die cavity.

In the magnetic powder hot-pressing and hot-deformation apparatus according to the present disclosure, preferably, the ratio of the diameter of the lower outer sleeve cavity to the diameter of the upper outer sleeve cavity is 1:(1.2-5.5), and the ratio of the diameter of the upper outer sleeve cavity to the diameter of the die cavity is 1:(1.05-1.5).

In the magnetic powder hot-pressing and hot-deformation apparatus according to the present disclosure, preferably, the length of the upper inner punch is greater than or equal to the length of the upper outer sleeve cavity, the length of the lower inner punch is greater than or equal to the length of the lower outer sleeve cavity, and the length of the lower outer sleeve is greater than or equal to the length of the female die.

Another aspect of the present disclosure provides a hot-pressing and hot-deformation method using the magnetic powder hot-pressing and hot-deformation apparatus described above, comprising:
(1) immobilizing the upper punch assembly, the female die, and the lower outer sleeve in the apparatus that has been assembled while moving the lower inner punch upward to apply pressure to a NdFeB magnetic powder so as to hot-press it, resulting in an NdFeB hot-pressed compact,
wherein the apparatus that has been assembled is in a state where the upper end of the lower outer sleeve is located inside the die cavity and the lower inner punch is away from the upper end of the lower outer sleeve so that in the die cavity, a first cavity is formed between the lower outer sleeve and the lower inner punch, where the first cavity accommodates the NdFeB magnetic powder, and where the bottom of the upper inner punch and the bottom of the upper outer sleeve are flush with each other and are in contact with the upper end of the lower outer sleeve;
(2) moving the upper inner punch upward such that a second cavity is formed between the upper inner punch and the upper outer sleeve, moving the lower inner punch upward until the upper end of the lower inner punch is flush with the upper end of the lower outer sleeve so that the NdFeB hot-pressed compact is brought into the second cavity, and immobilizing the lower punch assembly, the female die, and the upper outer sleeve while moving the upper inner punch downward to apply pressure to the NdFeB hot-pressed compact so as to pre-deform it, resulting in a pre-deformed compact; and
(3) moving the upper outer sleeve upward until its bottom is not lower than the bottom of the upper inner punch, keeping the position of the upper outer sleeve and the position of the upper inner punch unchanged relative to each other while letting the top of the lower inner punch be flush with the top of the lower outer sleeve, and moving the upper punch assembly and the lower punch assembly toward the pre-deformed compact to subject the pre-deformed compact to final deformation, resulting in an NdFeB magnet.

In the method according to the present disclosure, preferably, in step (1), the hot-pressing is performed in an inert atmosphere at a temperature of 500-700° C.; in step (2), the pre-deformation is performed in an inert atmosphere at a temperature of 650-900° C.; and in step (3), the final deformation is performed in an inert atmosphere at a temperature of 750-950° C.

In the method according to the present disclosure, preferably, in step (1) a pressure of 100-500 MPa is applied to the NdFeB magnetic powder for a duration of 10-500 s;
in step (2) a pressure of 50-500 MPa is applied to the NdFeB hot-pressed compact for a duration of 1-100 s; and
in step (3) a pressure of 80-600 MPa is applied to the pre-deformed compact for a duration of 30-300 s.

In the method according to the present disclosure, preferably, in step (3) the upper punch assembly is moved toward the pre-deformed compact at a speed of 0.7-1.5 times the speed at which the lower punch assembly is moved toward the pre-deformed compact.

In the method according to the present disclosure, preferably, the method further comprises: moving the upper punch assembly outside of the die cavity, moving the lower inner punch and/or the lower outer sleeve upward to push a compact from the final deformation outside of the die cavity, and cooling the compact from the final deformation to a temperature of 20-35° C., resulting in the NdFeB magnet.

In the method according to the present disclosure, preferably, the NdFeB magnetic powder is a rapid-quenching NdFeB fine powder.

The hot-pressing and hot-deformation apparatus of the present disclosure enables a magnetic powder to undergo hot-pressing and hot-deformation; it divides the hot-deformation process into pre-deformation that is performed at a low temperature and thereby causes small deformation and final deformation that is performed at a high temperature. This allows the NdFeB hot-pressed compact to be exposed to the high-temperature hot-deformation for a shorter duration, thereby decreasing the probability of crack formation in the magnet and improving its magnetic properties.

### BRIEF SUMMARY OF THE DRAWINGS

FIG. 1 is a schematic structural diagram of a magnetic powder hot-pressing and hot-deformation apparatus according to the present disclosure.

FIG. 2 is a schematic diagram of the state of the apparatus during the hot-pressing process.

FIG. 3 is a schematic diagram of the state of the apparatus during the pre-deformation process.

FIG. 4 is a schematic diagram of the state of the apparatus during the final deformation process.

The reference numerals of the components are as follows:
1: female die; 101: die cavity; 201: upper inner punch; 202: upper outer sleeve; 2021: upper outer sleeve cavity; 203: upper inner punch driver; 301: lower inner punch; 302: lower outer sleeve; 3021: lower outer sleeve cavity; 303: lower outer sleeve driver; 4: NdFeB hot-pressed compact; 5: pre-deformed compact; 6: compact from the final deformation.

### DETAIL DESCRIPTION OF THE DISCLOSURE

The following is a further description of the present disclosure by means of embodiments, but the present disclosure is not limited to those embodiments.

### Hot-Pressing and Hot-Deformation Apparatus for Magnetic Powder

The hot-pressing and hot-deformation apparatus of the present disclosure comprises a female die, an upper punch assembly, and a lower punch assembly. Each component is described in detail below.

### Female Die

The female die of the present disclosure comprises a die cavity. The die cavity comprises an upper cavity opening and a lower cavity opening. The die cavity may be in the shape of a cylinder, a cuboid, or the like. Each part of the die cavity has substantially the same diameter.

The die cavity may have a diameter of 10-100 mm. In some embodiments, the die cavity has a diameter of 20-70 mm.

### Upper Punch Assembly

The upper punch assembly of the present disclosure can be separated from the female die. The lower portion of the upper punch assembly can extend into the die cavity via the upper cavity opening.

The upper punch assembly comprises an upper inner punch and an upper outer sleeve. In some embodiments, the upper punch assembly further comprises an upper inner punch driver.

The upper outer sleeve comprises an upper outer sleeve cavity. The upper outer sleeve cavity extends throughout the upper outer sleeve. The ratio of the diameter of the upper outer sleeve cavity to the diameter of the die cavity may be 1:(1.05-1.5), preferably 1:(1.1-1.4), and more preferably 1:(1.2-1.3). Each part of the upper outer sleeve cavity has substantially the same diameter. The upper outer sleeve cavity may have a diameter of 5-70 mm. In some embodiments, the upper outer sleeve cavity has a diameter of 10-50 mm. This helps to improve the magnetic properties of the magnet.

The outer diameter of at least a portion of the upper outer sleeve matches the diameter of the die cavity. The length of the upper outer sleeve is greater than or equal to the length of the female die.

In some embodiments, the upper outer sleeve consists of a first upper outer sleeve unit and a second upper outer sleeve unit. The first upper outer sleeve unit is located above the second upper outer sleeve unit. The outer diameter of the second upper outer sleeve unit matches the diameter of the die cavity. The length of the second upper outer sleeve unit is greater than or equal to the length of the female die. The outer diameter of the first upper outer sleeve unit is greater than the outer diameter of the second upper outer sleeve unit, thereby forming a flange. The flange of the upper outer sleeve can serve to limit the movement of the upper inner punch.

When the upper punch assembly is combined with the female die, the central axis of the upper outer sleeve cavity coincides with the central axis of the die cavity.

At least a portion of the upper inner punch is inserted into the upper outer sleeve cavity. The upper inner punch is movable vertically relative to the upper outer sleeve. The outer diameter of the upper inner punch matches the diameter of the upper outer sleeve cavity. The length of the upper inner punch may be greater than or equal to the length of the upper outer sleeve cavity. The central axis of the upper inner punch may coincide with the central axis of the upper outer sleeve cavity.

The upper inner punch driver is connected to the top of the upper inner punch. The upper inner punch driver and the upper inner punch may be of an integrated structure.

Let S₁ denote the projection of the upper inner punch driver on a horizontal plane, and S₂ denote the projection of the upper inner punch on the horizontal plane. S₂ falls within the range of S₁. In some embodiments, the centers of S₁ and S₂ coincide with each other. The upper inner punch driver allows an externally applied pressure to be evenly distributed on the upper inner punch. This, in combination with the flange of the upper outer sleeve, can also serve to limit the movement of the upper inner punch.

### Lower Punch Assembly

At least a portion of the lower punch assembly of the present disclosure is located inside the die cavity. Specifically, the upper portion of the lower punch assembly extends into the die cavity via the lower cavity opening.

The lower punch assembly comprises a lower inner punch and a lower outer sleeve. In some embodiments, the lower punch assembly further comprises a lower inner punch driver.

The lower outer sleeve comprises a lower outer sleeve cavity. The lower outer sleeve cavity extends throughout the lower outer sleeve. The ratio of the diameter of the lower outer sleeve cavity to the diameter of the upper outer sleeve cavity may be 1:(1.2-5.5), preferably 1:(1.3-3), and more preferably 1:(1.4-2). Each part of the lower outer sleeve cavity has substantially the same diameter. The lower outer sleeve cavity may have a diameter of 2-50 mm. In some embodiments, the lower outer sleeve cavity has a diameter of 7-30 mm. This helps to improve the magnetic properties of the magnet.

The outer diameter of at least a portion of the lower outer sleeve matches the diameter of the die cavity. The length of the lower outer sleeve may be greater than or equal to the length of the female die.

In some embodiments, the lower outer sleeve consists of a first lower outer sleeve unit and a second lower outer sleeve unit. The first lower outer sleeve unit is located below the second lower outer sleeve unit. The outer diameter of the second lower outer sleeve unit matches the diameter of the die cavity. The length of the second lower outer sleeve unit is greater than or equal to the length of the female die. The outer diameter of the first lower outer sleeve unit is greater than the outer diameter of the second lower outer sleeve unit, thereby forming a flange. The flange of the lower outer sleeve can serve to limit the movement of the lower inner punch.

In some embodiments, the central axis of the lower outer sleeve cavity coincides with the central axis of the die cavity.

At least a portion of the lower inner punch is inserted into the lower outer sleeve cavity. The lower inner punch is movable vertically relative to the lower outer sleeve. The outer diameter of the lower inner punch matches the diameter of the lower outer sleeve cavity. The length of the lower inner punch may be greater than or equal to the length of the lower outer sleeve cavity. The central axis of the lower inner punch may coincide with the central axis of the lower outer sleeve cavity.

The lower inner punch driver is connected to the bottom of the lower inner punch. The lower inner punch driver and the lower inner punch may be of an integrated structure.

Let S₃ denote the projection of the lower inner punch driver on a horizontal plane, and S₄ denote the projection of the lower inner punch on the horizontal plane. S₄ falls within the range of S₃. In some embodiments, the centers of S₃ and S₄ coincide with each other. The lower inner punch driver allows an externally applied pressure to be evenly distributed on the lower inner punch. This, in combination with the flange of the lower outer sleeve, can serve to limit the movement of the lower inner punch.

### Hot-Pressing and Hot-Deformation Method

The hot-pressing and hot-deformation method of the present discloses employs the magnetic powder hot-pressing and hot-deformation apparatus described above and comprises: (1) a hot-pressing step, (2) a pre-deformation step, and (3) a final deformation step. Each step is described in detail below.

### Hot Pressing

The hot-pressing step comprises immobilizing the upper punch assembly, the female die, and the lower outer sleeve in the apparatus that has been assembled while moving the lower inner punch upward to apply pressure to a NdFeB magnetic powder so as to hot-press it, resulting in an NdFeB hot-pressed compact. The apparatus that has been assembled is in a state where the upper end of the lower outer sleeve is located inside the die cavity and the lower inner punch is away from the upper end of the lower outer sleeve so that in the die cavity, a first cavity is formed between the lower outer sleeve and the lower inner punch, where the first cavity accommodates the NdFeB magnetic powder, and where the bottom of the upper inner punch and the bottom of the upper outer sleeve are flush with each other and are in contact with the upper end of the lower outer sleeve.

Preferably, a release agent is applied to the apparatus before it is assembled. Specifically, the inner wall of the die cavity, the inner wall of the upper outer sleeve cavity, the outer surface of the upper inner punch, the inner wall of the lower outer sleeve cavity, and the outer surface of the lower inner punch may be coated with the release agent.

The NdFeB magnetic powder may a rapid-quenching magnetic powder. The NdFeB magnetic powder may comprise Pr, Nd, Fe, Co, Ga, and B. The total content of Pr and Nd may be 20-40 wt %, preferably 25-35 wt %. The mass ratio of Pr to Nd may be 25:(60-90), preferably 25:(70-80). The content of Fe may be 50-75 wt %, preferably 60-65 wt %. The content of Co may be 1-15 wt %, preferably 3-10 wt %. The content of Ga may be 0.1-3 wt %, preferably 0.3-1 wt %. The content of B may be 0.1-2 wt %, preferably 0.5-1.5 wt %.

In one embodiment of the present disclosure, the amount of the NdFeB magnetic powder used may be 60-120 g.

The hot-pressing is performed in an inert gas atmosphere. The inert gas is one or more selected from the group consisting of nitrogen, helium, neon, and argon. Preferably, the inert gas is argon.

The hot-pressing may be performed at a temperature of 500-700° C., preferably 550-650° C., and more preferably 600-620° C.

The hot-pressing may be performed at a speed of 0.05-5 mm/s, preferably 0.5-3 mm/s. In some embodiments, the hot-pressing is performed at a speed of 1-2 mm/s.

The pressure applied during the hot-pressing may be 100-500 MPa, preferably 250-400 MPa. In some embodiments, the pressure applied during the hot-pressing is 300-350 MPa.

The hot-pressing may be performed for a duration of 10-500 s, preferably 50-300 s, and more preferably 100-200 s.

The above conditions help to produce a dense, uniform isotropic NdFeB hot-pressed compact and improve the magnetic properties of the resultant magnet.

### Pre-Deformation

The pre-deformation step comprises moving the upper inner punch upward such that a second cavity is formed between the upper inner punch and the upper outer sleeve, moving the lower inner punch upward until the upper end of the lower inner punch is flush with the upper end of the lower outer sleeve so that the NdFeB hot-pressed compact is brought into the second cavity, and immobilizing the lower punch assembly, the female die, and the upper outer sleeve while moving the upper inner punch downward to apply pressure to the NdFeB hot-pressed compact so as to pre-deform it, resulting in a pre-deformed compact. The height of the second cavity is greater than or equal to the height of the NdFeB hot-pressed compact.

The pre-deformation is performed in an inert gas atmosphere. The inert gas is one or more selected from the group consisting of nitrogen, helium, neon, and argon. Preferably, the inert gas is argon.

The pre-deformation may be performed at a temperature of 650-900° C., preferably 680-800° C., and more preferably 700-750° C. The pre-deformation is performed at a temperature lower than the temperature at which the final deformation is performed.

The pre-deformation may be performed at a speed of 0.01-5 mm/s, preferably 0.05-2 mm/s. In some embodiments, the pre-deformation is performed at a speed of 0.1-0.5 mm/s.

The pressure applied during the pre-deformation may be 50-500 MPa, preferably 100-450 MPa. In some embodiments, the pressure applied during the pre-deformation is 270-300 MPa.

The pre-deformation may be performed for a duration of 1-100 s, preferably 10-80 s, and more preferably 20-50 s.

The above conditions for the pre-deformation help to reduce the occurrence of cracks in the resultant magnet and improve its magnetic properties.

### Final Deformation

The final deformation step comprises moving the upper outer sleeve upward until its bottom is not lower than the bottom of the upper inner punch, keeping the position of the upper outer sleeve and the position of the upper inner punch unchanged relative to each other while letting the top of the lower inner punch be flush with the top of the lower outer sleeve, and moving the upper punch assembly and the lower punch assembly toward the pre-deformed compact to subject the pre-deformed compact to final deformation, resulting in an NdFeB magnet.

In some embodiments, after moving the upper outer sleeve upward until its bottom becomes flush with the bottom of the upper inner punch, moving the upper punch assembly and the lower punch assembly toward the pre-deformed compact to subject the pre-deformed compact final deformation produces an NdFeB magnet block.

In some embodiments, after moving the upper outer sleeve upward until its bottom is higher than the bottom of the upper inner punch, moving the upper punch assembly and the lower punch assembly toward the pre-deformed compact to subject the pre-deformed compact final deformation produces an NdFeB magnet ring.

Preferably, the upper punch assembly is moved toward the pre-deformed compact at a speed of 0.7-1.5 times, preferably 0.9-1.2 times, and more preferably 1-1.1 times, the speed at which the lower punch assembly is moved toward the pre-deformed compact.

The final deformation is performed in an inert gas atmosphere. The inert gas is one or more selected from the group consisting of nitrogen, helium, neon, and argon. Preferably, the inert gas is argon.

The final deformation may be performed at a temperature of 750-950° C., preferably 800-900° C., and more preferably 840-880° C.

The final deformation may be performed at a speed of 0.01-3 mm/s, preferably 0.05-0.5 mm/s. In some embodiments, the final deformation is performed at a speed of 0.1-0.3 mm/s.

The final deformation may be performed at a pressure of 80-600 MPa, preferably 150-350 MPa. In some embodiments, the final deformation is performed at a pressure of 180-200 MPa.

The final deformation may be performed for a duration of 30-300 s, preferably 50-200 s, and more preferably 100-150 s.

In the present disclosure, the upper and lower punch assemblies pressurize the pre-deformed compact in two directions opposing each other, ensuring that more uniform force is applied to the pre-deformed compact. The above conditions for the final deformation step help to improve the magnetic properties of the resultant magnet.

In some embodiments, the method of the present disclosure further comprises: moving the upper punch assembly outside of the die cavity, moving the lower inner punch and/or the lower outer sleeve upward to push a compact from the final deformation outside of the die cavity, and cooling the compact from the final deformation to a temperature of 20-35° C., resulting in the NdFeB magnet.

The following is a description of the method for testing the magnetic properties of samples:

An NdFeB magnet block is cut into cylindrical samples with a diameter of 10 mm and a height of 3-5 mm by a wire Electrical Discharge Machining (EDM) machine. The magnetic properties of the samples are tested by a pulsed field magnetometer.

### EXAMPLES 1 TO 3

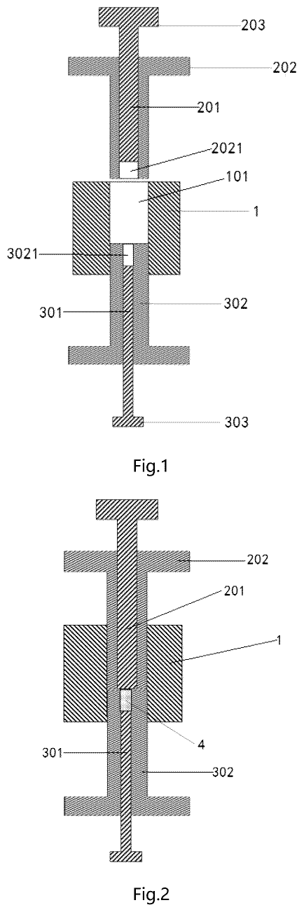

As is shown in FIG. 1, the magnetic powder hot-pressing and hot-deformation apparatus of these examples comprises a female die 1, an upper punch assembly, and a lower punch assembly.

The female die 1 comprises a die cavity 101. The die cavity 101 comprises an upper cavity opening and a lower cavity opening.

The upper punch assembly can be separated from the female die 1, and the lower part of the upper punch assembly can extend into the die cavity 101 via the upper cavity opening. The upper punch assembly comprises an upper inner punch 201, an upper outer sleeve 202, and an upper inner punch driver 203.

The upper outer sleeve 202 comprises an upper outer sleeve cavity 2021 that extends throughout the upper outer sleeve 202. The upper outer sleeve 202 consists of a first upper outer sleeve unit and a second upper outer sleeve unit. The first upper outer sleeve unit is located above the second upper outer sleeve unit. The first and second upper outer sleeve units are of an integrated structure. The outer diameter of the first upper outer sleeve unit is greater than the outer diameter of the second upper outer sleeve unit, thereby forming a flange. The central axis of the upper outer sleeve cavity 2021 coincides with the central axis of the die cavity 101. The length of the second upper outer sleeve unit is greater than the length of the female die 1. The outer diameter of the second upper outer sleeve unit matches the diameter of the die cavity 101.

A portion of the upper inner punch 201 is inserted into the upper outer sleeve cavity 2021. The upper inner punch 201 can move vertically relative to the upper outer sleeve 202. The outer diameter of the upper inner punch 201 matches the diameter of the upper outer sleeve cavity 2021. The length of the upper inner punch 201 is greater than the length of the upper outer sleeve cavity 2021. The central axis of the upper inner punch 201 coincides with the central axis of the upper outer sleeve cavity 2021.

The upper inner punch driver 203 is connected to the top of the upper inner punch 201. The upper inner punch driver 203 and the upper inner punch 201 are of an integrated structure. S₂ falls within the range of S₁, and the centers of S₁ and S₂ coincide with each other. S₁ denotes the projection of the upper inner punch driver 203 on a horizontal plane, and S₂ denote the projection of the upper inner punch 201 on the horizontal plane. The upper inner punch driver 203 allows an externally applied pressure to be evenly distributed on the upper inner punch 201. This, in combination with the flange of the upper outer sleeve 202, can also serve to limit the movement of the upper inner punch 201.

The lower punch assembly comprises a lower inner punch 301, a lower outer sleeve 302, and a lower outer sleeve driver 303.

At least a portion of the lower outer sleeve 302 extends into the die cavity 101 via the lower cavity opening. The lower outer sleeve 302 comprises a lower outer sleeve cavity 3021 that extends throughout the lower outer sleeve 302. The lower outer sleeve 302 consists of a first lower outer sleeve unit and a second lower outer sleeve unit. The first lower outer sleeve unit is located below the second lower outer sleeve unit. The outer diameter of the first lower outer sleeve unit is greater than the outer diameter of the second lower outer sleeve unit, thereby forming a flange. The central axis of the lower outer sleeve cavity 3021 coincides with the central axis of the die cavity 101. The length of the second lower outer sleeve unit is greater than the length of the female die 1. The outer diameter of the second lower outer sleeve unit matches the diameter of the die cavity 101. The diameter of the lower outer sleeve cavity 3021 is smaller than the diameter of the upper outer sleeve cavity 2021.

A portion of the lower inner punch 301 is inserted into the lower outer sleeve cavity 3021. The lower inner punch 301 can move vertically relative to the lower outer sleeve 302. The outer diameter of the lower inner punch 301 matches the diameter of the lower outer sleeve cavity 3021. The length of the lower inner punch 301 is greater than the length of the lower outer sleeve cavity 3021. The central axis of the lower inner punch 301 coincides with the central axis of the lower outer sleeve cavity 3021.

The lower inner punch driver 303 is connected to the bottom of the lower inner punch 301. The lower inner punch driver 303 and the lower inner punch 301 are of an integrated structure. S₄ falls within the range of S₃, and the centers of S₃ and S₄ coincide with each other. S₃ denotes the projection of the lower inner punch driver 303 on a horizontal plane. S₄ denotes the projection of the lower inner punch 301 on the horizontal plane. The lower inner punch driver 303 allows an externally applied pressure to be evenly distributed on the lower inner punch 301. This, in combination with the flange of the lower outer sleeve 302, can serve to limit the movement of the lower inner punch 301.

The diameters of the die cavity, the upper outer sleeve cavity, and the lower outer sleeve cavity are shown in Table 1.

TABLE 1

| | Diameter of | Diameter of Upper | Diameter of Lower |
|---|---|---|---|
| | Die Cavity | Outer Sleeve Cavity | Outer Sleeve Cavity |
| | (mm) | (mm) | (mm) |
| Example 1 | 40 | 33 | 21.9 |
| Example 2 | 30 | 25 | 16.4 |
| Example 3 | 40 | 33 | 9 |

### EXAMPLES 4 AND 5

The following steps were carried out to enable hot-pressing and hot-deformation using the magnetic powder hot-pressing and hot-deformation apparatus described above:
(1) Coat the inner wall of the die cavity 101, the inner wall of the upper outer sleeve cavity 2021, the outer surface of the upper inner punch 201, the inner wall of the lower outer sleeve cavity 3021, and the outer surface of the lower inner punch 301 with molybdenum disulfide as the release agent. Locate the upper end of the lower outer sleeve 302 inside the die cavity 101, and let the lower inner punch 301 be away from the upper end of the lower outer sleeve 302. This way, in the die cavity 101, a first cavity was formed between the lower outer sleeve 302 and the lower inner punch 301. Place 80 g of a rapid-quenching NdFeB magnetic powder into the first cavity. Cause the bottom of the upper inner punch 201 and the bottom of the upper outer sleeve 202 to be flush with each other and be in contact with the upper end of the lower outer sleeve 302. Thus, the assembled apparatus resulted (see FIG. 2).

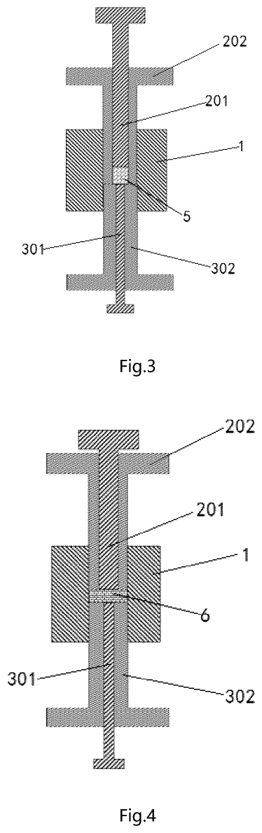

Place the assembled apparatus into the chamber of a heating device. Vacuum the chamber of the heating device and fill it with argon. Immobilize the upper punch assembly, the female die 1, and the lower outer sleeve 302 in the assembled apparatus while moving the lower inner punch 301 upward to apply pressure to the rapid-quenching NdFeB magnetic powder so as to hot-press it, resulting in an NdFeB hot-pressed compact 4.
(2) As is shown in FIG. 3, move the upper inner punch 201 upward by a distance that might be equal to the height of the NdFeB hot-pressed compact 4. This way, a second cavity was formed between the upper inner punch 201 and the upper outer sleeve 202. Move the lower inner punch 301 upward until the upper end of the lower inner punch 301 was flush with the upper end of the lower outer sleeve 302. This way, the NdFeB hot-pressed compact 4 was brought into the second cavity. Immobilize the lower punch assembly, the female die 1, and the upper outer sleeve 202 while moving the upper inner punch 201 downward to apply pressure to the NdFeB hot-pressed compact so as to pre-deform it, resulting in a pre-deformed compact 5.
(3) As is shown in FIG. 4, move the upper outer sleeve 202 upward until its bottom was flush with the bottom of the upper inner punch 201. Keep the bottom of the upper inner punch 201 flush with the bottom of the upper outer sleeve 202 while letting the top of the lower inner punch 301 be flush with the top of the lower outer sleeve 302. Move the upper punch assembly and the lower punch assembly toward the pre-deformed compact 5 at the same speed to subject the pre-deformed compact 5 to final deformation, resulting in a compact 6.

Move the upper punch assembly outside of the die cavity 101, move the lower punch assembly upward to push the compact 6 outside of the die cavity 101, and cool the compact 6 to a temperature of 25° C., resulting in a NdFeB magnet block.

The composition of the rapid-quenching NdFeB magnetic powder and the parameters of the above process are shown in Table 2. The properties of the resultant NdFeB magnet block are shown in Table 3.

TABLE 2

| | | Example 4 | Example 5 |
|---|---|---|---|
| Selection of hot-pressing and | | Example 1 | Example 2 |
| hot-deformation apparatus | | | |
| Composition of | PrNd (wt %) | 30.5 | 29.7 |
| rapid-quenching | Co (wt %) | 5 | 5 |
| NdFeB magnetic | Ga (wt %) | 0.5 | 0.5 |
| powder | B (wt %) | 0.9 | 0.9 |
| | Fe | Balance | Balance |

| | | |
|---|---|---|
| Hot-pressing temperature (° C.) | 600 | 620 |
| Hot-pressing speed (mm/s) | 1.5 | 1.5 |
| Hot-pressing pressure (MPa) | 350 | 350 |
| Hot-pressing duration (s) | 180 | 180 |
| Pre-deformation temperature (° C.) | 700 | 750 |
| Pre-deformation speed (mm/s) | 0.2 | 0.2 |
| Pre-deformation pressure (MPa) | 270 | 300 |
| Pre-deformation duration (s) | 30 | 30 |
| Final-deformation temperature (° C.) | 840 | 880 |
| Final-deformation speed (mm/s) | 0.1 | 0.1 |
| Final-deformation pressure (MPa) | 180 | 200 |
| Final-deformation duration (s) | 120 | 120 |

Note:
In PrNd, the content of Pr is 25 wt %, and the content of Nd is 75 wt %.

### COMPARATIVE EXAMPLE 1

The method of Example 4 of CN117116644A was performed to hot-press and hot-deform the same rapid-quenching NdFeB powder as in Example 4 of the present disclosure. The properties of the resultant NdFeB magnet block are shown in Table 3.

TABLE 3

| | | | Maximum Energy |
|---|---|---|---|
| | Remanence Br | Intrinsic Coercivity | Product (BH)ₘₐₓ |
| | (kGs) | H_{cJ} (kOe) | (MGOe) |
| Example 4 | 13.58 | 17.43 | 44.46 |
| Example 5 | 14.07 | 16.65 | 47.70 |
| Com. Ex. 1 | 13.1 | 15.67 | 40.47 |

The present disclosure is not limited to the embodiments described above. Any variation, improvement, and replacement which do not depart from the essence of the present disclosure and which those skilled in the art are able to think of fall within the scope of the present disclosure.

What is claimed is:

1. A a magnetic powder hot-pressing and hot-deformation apparatus, comprising a female die, an upper punch assembly, and a lower punch assembly,
wherein the female die comprises a die cavity comprising an upper cavity opening and a lower cavity opening;
the upper punch assembly comprises an upper inner punch and an upper outer sleeve, wherein the upper outer sleeve comprises an upper outer sleeve cavity, at least a portion of the upper inner punch is inserted into the upper outer sleeve cavity, the upper inner punch is configured to be movable vertically relative to the upper outer sleeve, and the outer diameter of the upper inner punch matches the diameter of the upper outer sleeve cavity; and
the lower punch assembly comprises a lower inner punch and a lower outer sleeve, wherein the lower outer sleeve comprises a lower outer sleeve cavity, at least a portion of the lower inner punch is inserted into the lower outer sleeve cavity, the lower inner punch is configured to be movable vertically relative to the lower outer sleeve, the diameter of the lower outer sleeve cavity is smaller than the diameter of the upper outer sleeve cavity, and the outer diameter of the lower inner punch matches the diameter of the lower outer sleeve cavity.

2. The magnetic powder hot-pressing and hot-deformation apparatus according to claim 1, wherein the outer diameter of at least a portion of the upper outer sleeve matches the diameter of the die cavity, and the outer diameter of at least a portion of the lower outer sleeve matches the diameter of the die cavity.

3. The magnetic powder hot-pressing and hot-deformation apparatus according to claim 1, wherein the ratio of the diameter of the lower outer sleeve cavity to the diameter of the upper outer sleeve cavity is 1:(1.2-5.5), and the ratio of the diameter of the upper outer sleeve cavity to the diameter of the die cavity is 1:(1.05-1.5).

4. The magnetic powder hot-pressing and hot-deformation apparatus according to claim 1, wherein the length of the upper inner punch is greater than or equal to the length of the upper outer sleeve cavity, the length of the lower inner punch is greater than or equal to the length of the lower outer sleeve cavity, and the length of the lower outer sleeve is greater than or equal to the length of the female die.

5. A hot-pressing and hot-deformation method using the magnetic powder hot-pressing and hot-deformation apparatus according to claim 1, comprising:
(1) immobilizing the upper punch assembly, the female die, and the lower outer sleeve in the apparatus that has been assembled while moving the lower inner punch upward to apply pressure to a NdFeB magnetic powder so as to hot-press it, resulting in an NdFeB hot-pressed compact,
wherein the apparatus that has been assembled is in a state where the upper end of the lower outer sleeve is located inside the die cavity and the lower inner punch is away from the upper end of the lower outer sleeve so that in the die cavity, a first cavity is formed between the lower outer sleeve and the lower inner punch, where the first cavity accommodates the NdFeB magnetic powder, and where the bottom of the upper inner punch and the bottom of the upper outer sleeve are flush with each other and are in contact with the upper end of the lower outer sleeve;
(2) moving the upper inner punch upward such that a second cavity is formed between the upper inner punch and the upper outer sleeve, moving the lower inner punch upward until the upper end of the lower inner punch is flush with the upper end of the lower outer sleeve so that the NdFeB hot-pressed compact is brought into the second cavity, and immobilizing the lower punch assembly, the female die, and the upper outer sleeve while moving the upper inner punch downward to apply pressure to the NdFeB hot-pressed compact so as to pre-deform it, resulting in a pre-deformed compact; and
(3) moving the upper outer sleeve upward until its bottom is not lower than the bottom of the upper inner punch, keeping the position of the upper outer sleeve and the position of the upper inner punch unchanged relative to each other while letting the top of the lower inner punch be flush with the top of the lower outer sleeve, and moving the upper punch assembly and the lower punch assembly toward the pre-deformed compact to subject the pre-deformed compact to final deformation, resulting in an NdFeB magnet.

6. The method according to claim 5, wherein in step (1), the hot-pressing is performed in an inert atmosphere at a temperature of 500-700° C.; in step (2), the pre-deformation is performed in an inert atmosphere at a temperature of 650-900° C.; and in step (3), the final deformation is performed in an inert atmosphere at a temperature of 750-950° C.

7. The method according to claim 5, wherein in step (1) a pressure of 100-500 MPa is applied to the NdFeB magnetic powder for a duration of 10-500 s;
in step (2) a pressure of 50-500 MPa is applied to the NdFeB hot-pressed compact for a duration of 1-100 s; and
in step (3) a pressure of 80-600 MPa is applied to the pre-deformed compact for a duration of 30-300 s.

8. The method according to claim 5, wherein in step (3) the upper punch assembly is moved toward the pre-deformed compact at a speed of 0.7-1.5 times the speed at which the lower punch assembly is moved toward the pre-deformed compact.

9. The method according to claim 5, further comprising: moving the upper punch assembly outside of the die cavity, moving the lower inner punch and/or the lower outer sleeve upward to push a compact from the final deformation outside of the die cavity, and cooling the compact from the final deformation to a temperature of 20-35° C., resulting in the NdFeB magnet.

10. The method according to claim 5, wherein the NdFeB magnetic powder is a rapid-quenching NdFeB fine powder.
